(19) United States
(12) Patent Application Publication
(10) Pub. No.: US 2026/0099590 A1
(43) Pub. Date: Apr. 9, 2026

(54) REMOTE ATTESTATION WITH TIMESTAMP AWARENESS

(71) Applicant: DENSO CORPORATION, Kariya (JP)

(72) Inventors: Carlos Mora-Golding, Southfield, MI (US); Ameer Kashani, Southfield, MI (US); Madoka Asai, Kariya (JP); Yasuharu Sugano, Kariya (JP); Tomonori Ikuse, Kariya (JP); Takeshi Nakamura, Torrance, CA (US)

(21) Appl. No.: 18/905,294

(22) Filed: Oct. 3, 2024

(51) Int. Cl. G06F 21/55

(52) U.S. Cl. CPC G06F 21/554; G06F 2221/034

(57) ABSTRACT

Systems, methods, and other embodiments described herein relate to using a time-based salt with remote attestation. In one embodiment, a method includes, responsive to communicating a remote attestation request to a remote device, receiving an attestation report from the remote device that includes an attestation report, the attestation report including at least one attestation hash that is formed from a salt and one or more integrity checks of data from the remote device that is to be verified. The method includes recreating the one or more integrity checks using a rainbow table. The method includes communicating a response to the remote device according to a result associated with the attestation report.

### TECHNICAL FIELD

The subject matter described herein relates in general to systems and methods for remote attestation and, more particularly, to using a time-based salt to facilitate remote attestation.

### BACKGROUND

Traditionally, vehicle security has involved a vehicle owner using a physical key to lock a door and/or start a vehicle manually. As technology advances, vehicle systems have morphed into more complex systems that involve additional features but also encounter additional/different risks. For example, many vehicles now include electronic systems that have the ability to collect data about the operation of the vehicle, communicate with remote systems, receive/provide electronic controls, and so on. However, along with enriched features and connectivity to outside networks comes the potential for attacks by malicious actors on computing systems in the vehicle that provide these advanced features. For example, malicious actors may attempt to gain access to vehicle systems in order to alter the operation of the vehicle, steal sensitive information, and so on.

The increase in cyber attacks creates new challenges in determining the integrity of systems after deployment. For example, remote attestation checks the integrity of a system through a process in which the system collaborates with a remote trusted entity. In particular, the system uses a hash function to validate the system data via a hash value that can be compared with a corresponding hash from a known valid state. However, remote attestation lacks information about when the integrity check occurred. The lack of time information creates a problem known as time-of-check time-of-use (TOCTOU), in which the memory of a system can be modified and restored without the knowledge of the system or the remote entity. This can result in failure to detect a compromised system. As such, existing solutions for remote attestation can encounter difficulties with different types of malicious attacks.

### SUMMARY

Example systems and methods associated with remote attestation using a time-based salt are disclosed. As previously noted, malicious attacks on the computing system of a vehicle can cause significant difficulties. While some attacks may simply expose sensitive information, other attacks may cause problems with the functioning of different vehicle systems. Thus, ensuring the validity of different systems can be a critical task. However, as noted, remote attestation further suffers from particular shortcomings associated with TOCTOU attacks, thereby potentially undermining system integrity. As such, effectively implementing security routines to avoid difficulties with different attacks can be complex.

Therefore, in one approach, an inventive system functions to secure a computing system within a device, such as a vehicle, by using a time-based salt when hashing for remote attestation. For example, a system, such as a vehicle, includes various data elements, such as program code and program data, that, if altered, can compromise the security of the system. As such, the system, in one approach, stores a hash of the data or multiple hashes of different segments of the data from a point when the data has a known valid state. Subsequently, a trusted entity may request that the system perform remote attestation, or the system may perform remote attestation with the trusted entity according to a defined schedule. This process of remote attestation generally involves the system attesting to the validity/security of the system so that interactions between the system and other devices can be trusted and/or to ensure the system remains in a valid state. In either case, the system initiates remote attestation by collecting the data within the system and generating integrity checks, which may be in the form of hashes of the data. The system may segment the data and generate multiple hashes or generate a single hash over the data. Moreover, while a single instance of performing the integrity checks in relation to the attestation request is discussed, in various arrangements, the system may generate the integrity checks at various times (e.g., at regular or irregular intervals) in order to provide checks of the data over time.

Whichever approach is undertaken, the integrity check is of the data of the system and thus reflects any changes in comparison to the valid version for which a prior hash can be stored for comparison (e.g., either locally or remotely in the cloud). The system may further generate a report of the attestation that is communicated to the requesting remote entity, which also serves as the trusted party. As part of generating the report, the system, in at least one approach, generates an attestation hash, which, in at least one embodiment, may be a list of attestation hashes. For example, the system applies a hash function along with a salt to the integrity checks to generate the attestation hash, which is included in the communication to the remote entity. The salt is a value that is applied with the hash function when hashing the integrity checks to further randomize the output. For example, the salt may be appended to the data being hashed. In at least one arrangement, the salt is comprised of a shared secret (e.g., a random number) that is shared between the system and the remote entity as well as a time. The time is the time at which the system performs the remote attestation (i.e., hashing). The system may acquire the time from a trusted local clock, a remote time service, a Network Time Security (NTS) server, or another trusted source. In any case, the system uses the shared secret and the time to form the salt, thereby intrinsically correlating the attestation hash with the time at which the attestation is performed. In further arrangements, the system may generate multiple attestation hashes with separate hashes or groups of hashes being from the different time intervals, as previously mentioned. That is, instead of generating a single combined attestation hash of all of the integrity hashes, the system may instead generate attestation hashes at different times and directly of the data of the vehicle. This results in the system directly correlating the time of the hash via the salt with each separate attestation hash, thereby providing a mechanism for checking the integrity of the system between requests. In either case, the system then communicates this information (i.e., the attestation hash) to the remote entity for verification responsive to the request.

The remote entity, which is functioning as the trusted party, then attempts to calculate the integrity checks. In one approach, instead of re-hashing the data and comparing the hashes, the remote entity uses a rainbow table to calculate the integrity hashes from the attestation hash, whether provided as a single attestation hash or a list of attestation hashes associated with the different attestation times. For example, the remote entity pre-computes the rainbow table according to different possible values of the salt for the known valid data. Because the salt only changes in relation to the time, the remote entity can pre-compute the rainbow table according to different times at which the attestation may occur. In general, the remote entity is aware of a range of times, either based on the request or the schedule at which the attestation occurs. Thus, the remote entity computes the rainbow table based on the expected time(s) of the remote attestation.

The remote entity can then use the integrity check and the shared secret to look up the time within the rainbow table. If the integrity check matches, then the time can be identified. Thus, the matching integrity check indicates that the attestation is valid. However, if the integrity check does not match, then the time cannot be identified within the rainbow table, and the attestation is not valid. If one attestation hash cannot be decoded, then the system may proceed by traversing the list of attestation hashes from the different times in order to determine a time when the system became corrupt. Moreover, the remote entity may perform further actions based on the attestation. For example, the remote entity may determine whether the identified time from the rainbow table satisfies a risk threshold. The risk threshold defines a range of time within which the attestation is expected to be performed. If the attestation occurs outside of this time, then this may indicate that a time-of-check, time-of-use (TOCTOU) attack is occurring. Accordingly, the remote entity may then provide a communication to the attesting device depending on the result. If the result is that the attestation is not valid, then the communication may be to mitigate the compromised data. If the result is that the risk threshold is not satisfied, then the communication may request a further priority attestation in an attempt to confirm the validity. In this way, the use of the time with the salt permits the remote entity to better validate the attesting device and avoid various attacks while also permitting refined tracing of occurrences of attacks according to specific times.

In one embodiment, a security system is disclosed. The security system includes one or more processors and a memory that is communicably coupled to the one or more processors. The memory stores a control module including instructions that, when executed by the one or more processors, cause the one or more processors to, responsive to communicating a remote attestation request to a remote device, receive an attestation report from the remote device that includes at least an attestation hash, the attestation hash being formed from a salt and one or more integrity checks of data from the remote device that is to be verified. The control module including instructions to recreate the one or more integrity checks using a rainbow table. The control module including instructions to communicate a response to the remote device according to a result associated with the integrity checks.

In one embodiment, a non-transitory computer-readable medium is disclosed. The computer-readable medium stores instructions that, when executed by one or more processors, cause the one or more processors to perform the disclosed functions. The instructions include instructions to, responsive to communicating a remote attestation request to a remote device, receive an attestation report from the remote device that includes at least an attestation hash, the attestation hash being formed from a salt and one or more integrity checks of data from the remote device that is to be verified. The instructions including instructions to recreate the one or more integrity checks using a rainbow table. The instructions including instructions to communicate a response to the remote device according to a result associated with the integrity checks.

In one embodiment, a method is disclosed. The method includes, responsive to communicating a remote attestation request to a remote device, receiving an attestation report from the remote device that includes at least an attestation hash, the attestation hash being formed from a salt and one or more integrity checks of data from the remote device that is to be verified. The method includes recreating the one or more integrity checks using a rainbow table. The method includes communicating a response to the remote device according to a result associated with the integrity checks.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a configuration of a vehicle in which example systems and methods may be implemented.

FIG. 2 illustrates one embodiment of a security system that is associated with remote attestation using a time-based salt.

FIG. 3 is a flowchart showing one embodiment of a method for performing remote attestation in a device using a salt.

FIG. 4 illustrates a system flow diagram of functions performed by separate entities associated with remote attestation.

FIG. 5 is a flowchart showing one embodiment of a method for requesting attestation and validating results of remote attestation.

FIG. 6 is a flowchart showing a system flow diagram of functions performed to validate the results of a remote attestation.

### DETAILED DESCRIPTION

Systems, methods, and other embodiments associated with remote attestation using a time-based salt are disclosed. As previously noted, malicious attacks on the computing system of a vehicle can cause significant difficulties. While some attacks may simply expose sensitive information, other attacks may cause problems with the functioning of different vehicle systems. Thus, ensuring the validity of different systems can be a critical task. However, as noted, remote attestation further suffers from particular shortcomings associated with TOCTOU attacks, thereby potentially undermining system integrity. As such, effectively implementing security routines to avoid difficulties with different attacks can be complex.

Therefore, in one approach, an inventive system functions to secure a computing system within a device, such as a vehicle, by using a time-based salt when hashing for remote attestation. For example, a system, such as a vehicle, includes various data elements, such as program code and program data, that, if altered, can compromise the security of the system. As such, the system, in one approach, stores a hash of the data or multiple hashes of different segments of the data from a point when the data has a known valid state. Subsequently, a trusted entity may request that the system perform remote attestation, or the system may perform remote attestation with the trusted entity according to a defined schedule. This process of remote attestation generally involves the system attesting to the validity/security of the system so that interactions between the system and other devices can be trusted and/or to ensure the system remains in a valid state. In either case, the system initiates remote attestation by collecting the data within the system and generating integrity checks, which may be in the form of hashes of the data. The system may segment the data and generate multiple hashes or generate a single hash over the data. Moreover, while a single instance of performing the integrity checks in relation to the attestation request is discussed, in various arrangements, the system may generate the integrity checks at various times (e.g., at regular or irregular intervals) in order to provide checks of the data over time.

Whichever approach is undertaken, the integrity check is of the data of the system and thus reflects any changes in comparison to the valid version for which a prior hash can be stored for comparison (e.g., either locally or remotely in the cloud). The system may further generate a report of the attestation that is communicated to the requesting remote entity, which also serves as the trusted party. As part of generating the report, the system, in at least one approach, generates an attestation hash, which, in at least one embodiment, may be a list of attestation hashes. For example, the system applies a hash function along with a salt to the integrity checks to generate the attestation hash, which is included in the communication to the remote entity. The salt is a value that is applied with the hash function when hashing the integrity checks to further randomize the output. For example, the salt may be appended to the data being hashed. In at least one arrangement, the salt is comprised of a shared secret (e.g., a random number) that is shared between the system and the remote entity, as well as a time. The time is the time at which the system performs the remote attestation (i.e., hashing). The system may acquire the time from a trusted local clock, a remote time service, or another trusted source. In any case, the system uses the shared secret and the time to form the salt, thereby intrinsically correlating the attestation hash with the time at which the attestation is performed. In further arrangements, the system may generate multiple attestation hashes with separate hashes or groups of hashes being from the different time intervals, as previously mentioned. That is, instead of generating a single combined attestation hash of all of the integrity hashes, the system may instead generate attestation hashes at different times and directly of the data of the vehicle. This results in the system directly correlating the time of the hash via the salt with each separate attestation hash, thereby providing a mechanism for checking the integrity of the system between requests. In either case, the system then communicates this information (i.e., the attestation hash) to the remote entity for verification responsive to the request.

The remote entity, which is functioning as the trusted party, then attempts to calculate the integrity checks. In one approach, instead of re-hashing the data and comparing the hashes, the remote entity uses a rainbow table to calculate the integrity hashes from the attestation hash, whether provided as a single attestation hash or a list of attestation hashes associated with the different attestation times. For example, the remote entity pre-computes the rainbow table according to different possible values of the salt for the known valid data. Because the salt only changes in relation to the time, the remote entity can pre-compute the rainbow table according to different times at which the attestation may occur. In general, the remote entity is aware of a range of times, either based on the request or the schedule at which the attestation occurs. Thus, the remote entity computes the rainbow table based on the expected time of the remote attestation.

The remote entity can then use the integrity check and the shared secret to look up the time within the rainbow table. If the integrity check matches, then the time can be identified. Thus, the matching integrity check indicates that the attestation is valid. However, if the integrity check does not match, then the time cannot be identified within the rainbow table, and the attestation is not valid. If one attestation hash cannot be decoded, then the system may proceed by traversing the list of attestation hashes from the different times by using the rainbow table in order to determine a time when the system became corrupt. This may facilitate a time at which the system became corrupted and may indicate the occurrence of a time-of-check, time-of-use (TOCTOU) attack. Moreover, the remote entity may perform further actions based on the attestation. For example, the remote entity may determine whether the identified time from the rainbow table satisfies a risk threshold. The risk threshold defines a range of time within which the attestation is expected to be performed. If the attestation occurs outside of this time, then this may indicate that a TOCTOU attack is occurring. Accordingly, the remote entity may then provide a communication to the attesting device depending on the result. If the result is that the attestation is not valid, then the communication may be to mitigate the compromised data. If the result is that the risk threshold is not satisfied, then the communication may request a further priority attestation in an attempt to confirm the validity. In this way, the use of the time with the salt permits the remote entity to better validate the attesting device and avoid various attacks while also permitting refined tracing of occurrences of attacks according to specific times.

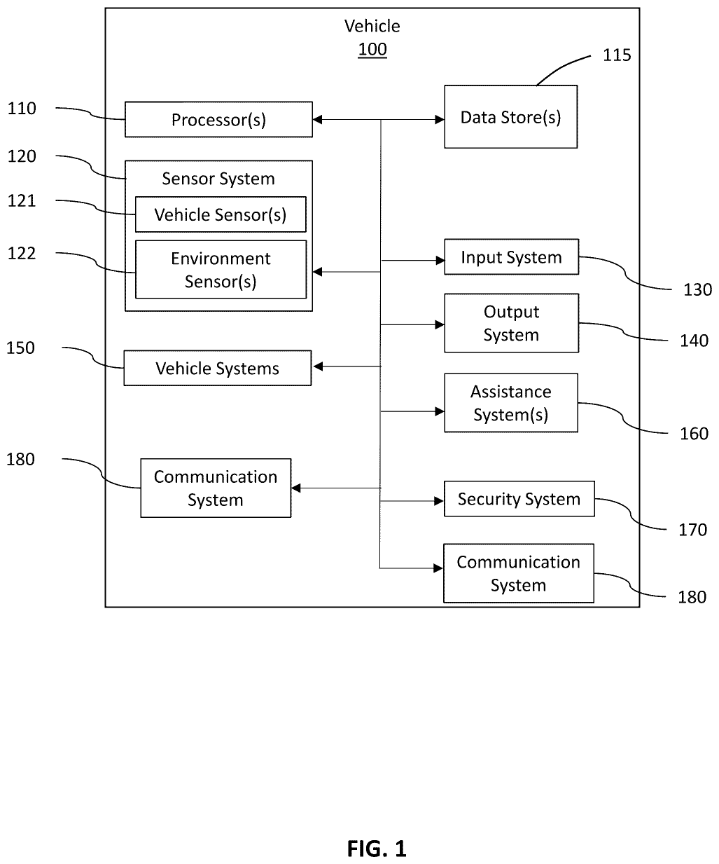

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may instead be an electronic device associated with transportation infrastructure (e.g., roadside unit), a cloud-based system communicating with mobile devices, or other devices that may implement electronic systems that are potentially vulnerable to malicious attack, and thus benefit from the functionality discussed herein.

The vehicle 100 also includes various elements. It will be understood that, in various embodiments, the vehicle 100 may not have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may, at least in part, be physically separated by large distances and provided as remote services (e.g., cloud-computing services, application programming interfaces, etc.).

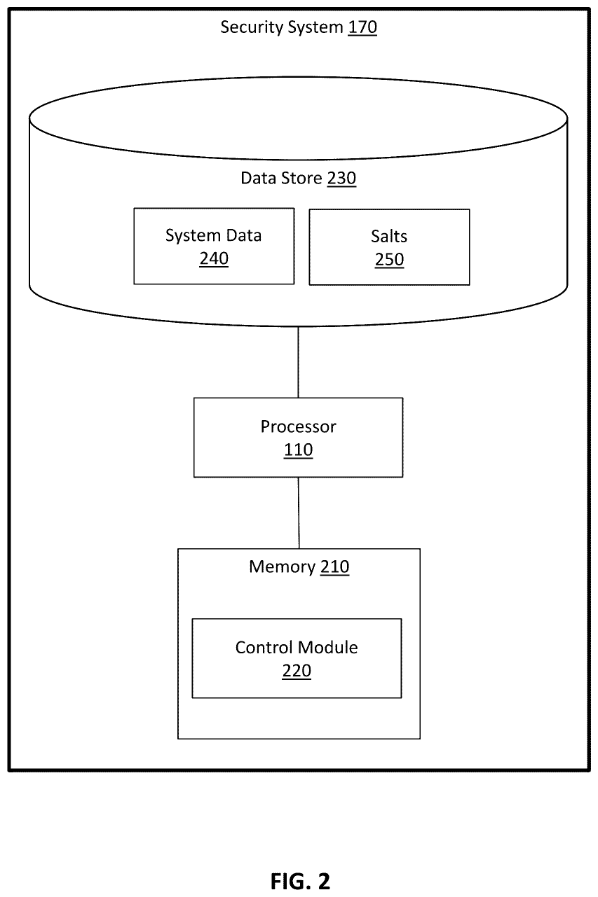

Some of the possible elements of the vehicle 100 are shown in FIG. 1 and will be described along with subsequent figures. A description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding, analogous, or similar elements. Furthermore, it should be understood that the embodiments described herein may be practiced using various combinations of the described elements.

In any case, the vehicle 100 includes a security system 170 that functions to improve the security of the vehicle 100 by implementing a process for performing attestation to better secure system data against malicious attacks. Moreover, while depicted as a standalone component, in one or more embodiments, the security system 170 is integrated with another system of the vehicle 100 to facilitate improving the security of functions of the systems/modules associated with automated driving and/or other controls of the vehicle 100. The noted functions and methods will become more apparent with a further discussion of the figures. Additionally, it should be appreciated that, as described herein, various functions are discussed as being performed by an attesting device and other functions are described as being performed by a remote entity, which may request the attestation. In this arrangement, the security system 170 may be implemented as separate instances within the associated devices. As such, the description of the security system 170 may involve distributed instances that function in separate roles.

With reference to FIG. 2, one embodiment of the security system 170 is further illustrated. As shown, the security system 170 includes a processor 110. Accordingly, the processor 110 may be a part of the security system 170, or the security system 170 may access the processor 110 through a data bus or another communication pathway. In one or more embodiments, the processor 110 is an application-specific integrated circuit that is configured to implement functions associated with a control module 220. More generally, in one or more aspects, the processor 110 is an electronic processor, such as a microprocessor, that is capable of performing various functions as described herein when executing encoded functions associated with the security system 170. Moreover, the processor 110 or another electronic processing unit associated with the security system 170 executes various programs (also referred to herein as software components, program data/code, and/or instructions) that are to be secured/protected.

In various embodiments, the particular functionality of a program may vary but can include automated driving functions (e.g., ADAS functions, machine perception, mapping, object detection/identification, path planning, vehicle control routines, and so on), functions associated with control of the vehicle 100, execution of infotainment systems within the vehicle 100, operating systems and associated components, and so on. Thus, various aspects of the program may be related to the functional safety of the vehicle 100, sensitive/personal information, system operation, and so on, which may be targeted by attackers because of the sensitive/critical information associated therewith. Furthermore, it should be appreciated that the program itself can be structured in different ways but is generally formed of multiple segments. The segments include data elements (e.g., variables), and various functions (i.e., blocks of code associated with performing a particular function). Additionally, the programs/software components are comprised of, in at least one arrangement, static data elements. The static data elements include aspects such as source files, text files, and so on.

Moreover, while the programs are generally described from a functional viewpoint, it should be appreciated that the programs may take different forms. That is, the programs may be firmware, operating systems, applications, trusted applications (Tas), and so on. In any case, as described herein, the programs and associated data form the system data (e.g., system data 240, also described as program code/data) as described herein. As will be explained in further detail subsequently, the system data 240 can be divided into segments of a particular size. The security system 170 may define the size dynamically according to, for example, a condition of the security system 170 or other device or as a predefined size (e.g., a packet payload size, a buffer size, etc.).

Continuing with elements of the security system 170, in one embodiment, the security system 170 includes a memory 210 that stores the control module 220 and, in various configurations, additional elements (e.g., system data 240). The memory 210 is a random-access memory (RAM), read-only memory (ROM), a hard disk drive, a flash memory, or other suitable memory for storing the module 220. In any case, the control module 220 is, for example, computer-readable instructions that, when executed by the processor 110, cause the processor 110 to perform the various functions disclosed herein. While, in one or more embodiments, the module 220 is instructions embodied in the memory 210, in further aspects, the module 220 includes hardware, such as processing components (e.g., controllers), circuits, etc. for independently performing one or more of the noted functions. Thus, the control module 220 may be embodied as instructions within the memory 210 or as a standalone component, such as a system-on-a-chip (SoC), ASIC, or another electronic device. Moreover, the control module 220 may be further embodied in separate instances, such as an instance within the vehicle 100 and an instance within a remote device, such as a cloud-based monitoring service or another vehicle. As will be described in further detail subsequently, the remote device may be another entity that interacts with the vehicle 100 and, thus, confirms the integrity of the vehicle 100. Similarly, the remote entity may be a cloud-based resource, such as secure vehicle data access broker or a security monitoring service of an OEM that functions to maintain the security of vehicles from a manufacturer.

Furthermore, in one embodiment, the security system 170 includes a data store 230. The data store 230 is, in one arrangement, an electronically-based data structure for storing information. For example, in one approach, the data store 230 is a database that is stored in the memory 210 or another suitable electronic storage medium (e.g., RAM, on-chip cache, etc.), and that is configured with routines that can be executed by the processor 110 for analyzing stored data, providing stored data, organizing stored data, and so on. In any case, in one arrangement, the data store 230 stores data used by the control module 220 in executing various functions. In one embodiment, the data store 230 includes system data 240 and one or more salts 250 along with, for example, other information that is used by the control module 220. As previously noted, the system data 240 includes program code and/or program data that includes applications and associated data of the attesting device. The individual salts 250 are combined values that include a shared secret (e.g., a random number) and a time that is updated for when the individual salts 250 are used at a current time.

Turning to the functioning of the control module 220, in general, the control module 220 includes instructions that function to control the processor 110 to validate the system data 240 responsive to an attestation request. It should be noted that while validation of the system data 240 can occur responsive to the attestation request, in various arrangements, the security system 240 may perform other actions at intervals (e.g., regular or irregular) in order to capture a state of the vehicle 100, as will be discussed further subsequently. The system data 240 is generally memory contents of a memory within the device and includes program code, data objects, configuration files, and other program information used by the program in execution. The control module 220, in one approach, hashes the system data 240 either as a complete block or as segments to generate representations of the system data 240 as integrity hashes. The control module 220 may receive the system data 240 in segments of a particular size. The control module 220 may determine the size of the segments and control how the segments are acquired. The control module 220 may determine the predefined size according to the size of a buffer/cache or other memory (e.g., a working memory associated with the control module 220), a defined transmission size for a protocol (e.g., TCP packet payload size), or according to another attribute of the system 170 that defines a working memory for the control module 220. Alternatively, the control module 220 dynamically defines the size of the segments.

In any case, the control module 220, in at least one approach, applies a cryptographic hash function (e.g., MD4, MD5, SHA-1, SHA-2, SHA-3, ASCON, etc.) to the segments to derive the integrity hashes when combining the hashes together into a single attestation hash for a given integrity check of the vehicle 100. Depending on the particular implementation, the control module 220 may plainly hash the segments or may hash the segments using a salt for a current time in order to generate a list of attestation hashes. Accordingly, the hashes of the segments may serve directly as the attestation hash/list, or the control module 220 may proceed to generate an attestation hash that uses the salt 250 with plain hashes of the segments. In either case, the control module 220 determines a current time from a trusted source, such as a trusted internal clock, a remote service, Network Time Security (NTS) server, or another trusted entity to determine the salt 250. In general, the primary consideration is that the acquired current time is accurate so that the trusted party can effectively track the attestation process and know that the system 170 performed the attestation when requested and within a reasonable time of the request.

The control module 220 proceeds to join the time with a shared secret to form the salt 250. The control module 220 may simply append the time in a defined format to the shared secret and then hash the salt 250 with the integrity check/segments or combined integrity hashes. The attestation hash may be realized as either a single hash or a list of hashes separately related to the segments. It should be appreciated that the time may take different forms but is generally comprised of a time of day, along with the day, month, and year. The time may be provided in an epoch format or similar offset-based method, a twelve-hour format, including an indicator of AM or PM, or a twenty-four-hour format. Moreover, the time can be provided with different levels of precision depending on the implementation. In general, the time includes the hour, minute, and nearest second. However, in further arrangements, millisecond, microsecond, nanosecond, picosecond, or greater precision may be included so as to exceed an adversarial capacity for time-of-check time-of-use (TOCTOU) attacks.

The shared secret is understood to be a pseudo-random number that can be generated by a pseudo-random number generator by either the system 170 within the vehicle 100 or the remote entity. The shared secret is generally shared in a secure manner upon establishing a relationship between the vehicle 100 and the remote entity and may be updated according to a defined schedule or a particular event (e.g., the occurrence of a defined number of attestations). The control module 220 can then use the combined time and shared secret as the salt 250. To hash the integrity hashes or the segments individually, the control module 220 may append the salt 250 to the element being hashed and apply a hash algorithm to derive the attestation hash, which the control module 220 can provide along with a report to the remote entity. It should be noted that while the system 170 may generate the attestation hash(es) in response to an attestation request, the system 170 may further, in at least one arrangement, generate the attestation hash(es) prior to receiving a request and/or between receiving attestation requests. That is, the system 170 may generate the attestation requests at intervals in order to capture a state of the vehicle at different times so that subsequent checks of the integrity during an attestation may further trace when a system becomes compromised and may further thwart complex attacks, such as TOCTOU attacks.

Additional aspects of the security system 170 and attestation requests will be described in relation to subsequent figures. In any case, it should be appreciated that the security system 170 generates the attestation and/or integrity hashes in order to verify and attest to the integrity of the system data 240 on the vehicle 100. In this way, the security system 170 is able to confirm the software is valid and has not been corrupted and, therefore, facilitates interactions with remote devices (i.e., relying parties) by confirming the system data 240 is not compromised and thus will not compromise the remote devices when interacting therewith.

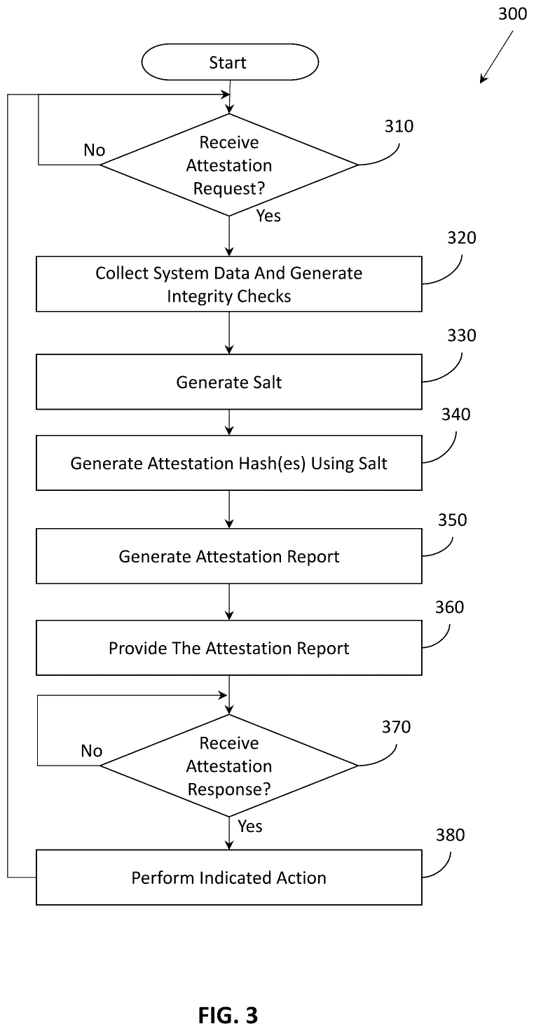

Additional aspects of securing electronic systems of a vehicle against malicious attacks will be discussed in relation to FIG. 3. FIG. 3 illustrates a method 300 associated with performing remote attestation using a salt. Method 300 will be discussed from the perspective of the security system 170 of FIGS. 1 and 2. While method 300 is discussed in combination with the security system 170, it should be appreciated that the method 300 is not limited to being implemented within the security system 170 but is instead one example of a system that may implement the method 300.

At 310, the control module 220 monitors for an attestation request. The attestation request may be generated automatically within the system 170 or may be received from a remote entity. For example, the remote entity generates the attestation request as a regular monitoring function to check the vehicle 100 for continued integrity. In a further example, the remote entity generates the attestation request when connecting with the vehicle 100 to provide a service and/or to receive information from the vehicle 100. In general, the attestation request and subsequent verification function as a way for the remote entity to verify the integrity of the vehicle 100. Alternatively, or additionally, the security system 170 generates internal requests according to a schedule to attest to the remote entity. The schedule may define regular or irregular intervals for performing the attestation. In at least one arrangement, the schedule defines conditions or events for inducing an attestation request, such as the occurrence of a request to connect with another device, a particular program action, and so on. In any case, the form of the attestation request itself may vary depending on the implementation but generally includes a generic request for the security system 170 to initialize attestation and may further include verification information about a requesting party, such as a signed digital certificate or other cryptographic element to verify the identity of the source. As such, the control module 220 monitors for the attestation request at 310 and proceeds with subsequent actions upon identifying receipt of the attestation request.

At 320, the control module 220 collects the system data 240 responsive to the attestation request to generate the integrity checks. In general, the control module 220 collects the system data 240 as segments according to a segment size. Of course, in further arrangements, the control module 220 collects the system data 240 as a whole (e.g., a contiguous memory space). The segment size can be predefined or dynamically determined. It should be noted that the process of performing attestation, as described with method 300, in one or more configurations, may occur within a secure coprocessor, such as trusted execution environment (TEE) of the attesting device. Thus, the attestation request and the segments of data may be passed into the secure coprocessor.

Depending on the particular implementation, the process of performing the integrity check, as described herein, may vary. In one approach, the system 170 generates integrity hashes of the data segments according to a hash function. In general, the control module 220 generates the integrity hashes iteratively by hashing the segments of the system data 240 or the entirety of the system data 240 at once. As a result, the control module 220 provides integrity hashes in order to characterize a state of the vehicle 100. In further arrangements, the system 170 performs the integrity check by simply collecting the segments of the system data 240, which are then subsequently used to generate a list of attestation hashes.

At 330, the control module 220 generates the salt 250. In at least one arrangement, the control module 220 generates the salt 250 by determining a current time. That is, the control module 220 retrieves the current time from an internal clock of the vehicle 100 or another source, such as a remote time service. In either case, the control module 220 combines the time with a shared secret between the remote entity and the vehicle 100 to form the salt 250. In general, the control module 220 concatenates, logically XORs, or appends the time to the shared secret to form the salt 250. As previously described, the time may be provided in different forms depending on the implementation and the shared secret is a pseudo-random number of a defined length (e.g., 128 bits, 256 bits, etc.).

At 340, the control module 220 generates an attestation hash(es) using the salt 250. In at least one arrangement, the control module 220 hashes one of the integrity hash(es) or the collected segments using the salt 250 and the shared secret to form the attestation hash(es). The attestation hash(es) then serve as a way to incorporate the results of the attestation along with the time so that the time is memorialized with the results. The control module 220 can then provide the attestation hash to the remote entity as described further subsequently. As noted previously, the system 170 may further generate the attestation hashes(es) when there is no explicit attestation request at intervals prior to the explicit request in order to further maintain a record of the integrity of the vehicle 100.

At 350, the control module 220 generates an attestation report about the result of the attestation. The attestation report may include different information depending on the implementation. For example, the control module 220 generates the report with the attestation hash(es), including any prior attestation hashes from before the explicit request. In one or more arrangements, the control module 220 may instead generate the generate the attestation report with only the most recent attestation hash in order to, for example, minimize the bandwidth necessary to transmit the report. Thus, the requestor may subsequently follow-up by requesting the prior attestations when, for example, further investigation is deemed necessary due to a failed hash reconstruction, failing to meet the risk threshold, and so on. In general, by providing the attestation report, the system permits the remote entity to perform a forensic investigation of the system data 240.

At 360, the control module 220 provides the attestation report. The control module 220 provides the attestation report by communicating the report to the remote entity (i.e., the requesting device) over a communication channel, such as the Internet. After providing the report, the control module 220, at 370, may then monitor for a subsequent acknowledgment communication from the remote entity or another attestation response. The attestation response communication may include various information depending on the result. For example, a positive report (i.e., the system data 240 is valid) may induce the authorization of a critical transaction or privileged function, along with the creation of a direct link/connection for exchanging information with the remote entity for which information about the connection may be included in the response communication. When the report is negative and/or the remote entity determines that a positive report is not timely (i.e., fails to satisfy the risk threshold), the attestation response may be a mitigation message that specifies a mitigation action for the security system 170 to perform.

At 380, the control module 220 performs an indicated action according to the attestation response. As noted, when the result of the attestation is negative, or the remote entity determines that the time of the attestation does not satisfy a risk threshold (e.g., the time exceeds a permitted range), then the attestation response is configured to cause an attesting device to perform the mitigation action. For example, in the case of the time not satisfying the risk threshold, the remote entity may request the attesting device (i.e., the vehicle 100) to perform a priority attestation. The priority attestation is a remote attestation procedure that is immediately undertaken by the attesting device without delay. In one or more arrangements, the attesting device may disable or reduce functionality (e.g., multimedia functions, autonomous driving functions, etc.) so that the vehicle 100 can perform the priority attestation promptly and with more available computational resources.

In further arrangements, the mitigation action can be different actions or sets of actions depending on the implementation. In general, the mitigation action is designed to correct or at least mitigate further harm from a malicious attack. By way of example, the mitigation action can include restoring a memory of the attesting device (i.e., the system data 240), disabling at least a portion of the attesting device (i.e., one or more systems within the vehicle 100), collecting data from the vehicle 100 for analysis (e.g., logs, kernel messages, IDPS data, raw memory data, etc.) that is sent to the remote entity, or another mitigating action.

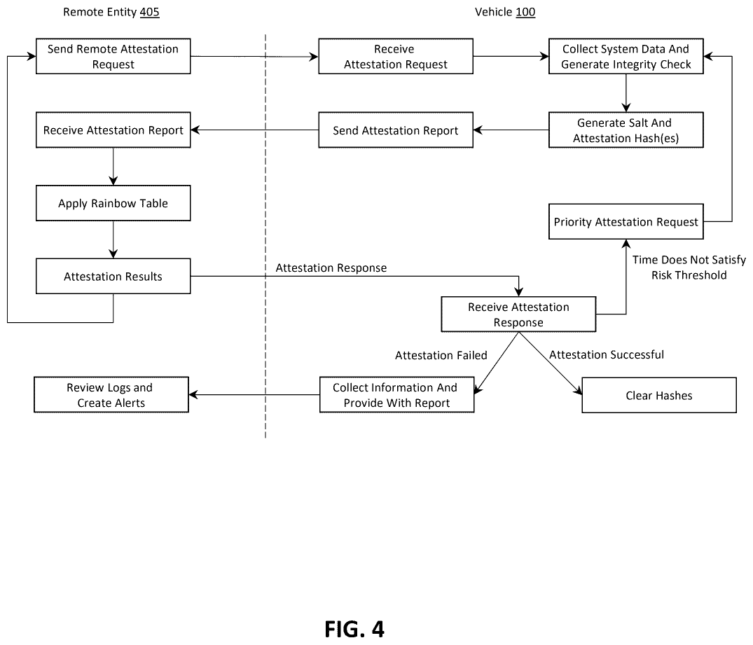

As further explanation of the attestation process, consider FIG. 4. FIG. 4 illustrates an example process flow 400 between a remote entity 405 and the vehicle 100 within which the security system 170 is performing attestation. As shown, the remote entity 405 sends the remote attestation request to initiate the attestation process, which is generally when the attesting party provides information about the integrity of the attesting system. The vehicle 100 receives the attestation request and proceeds to collect the system data 240, generate the integrity checks, and generate the attestation hash(es) using the salt 250, which includes determining a current time. The vehicle 100 can then send the attestation report about the results of the attestation to the remote entity 405.

The remote entity 405 then functions to verify the attestation results indicated in the report when received. Thus, the remote entity 405 receives the attestation report from the vehicle 100. The attestation report includes the attestation hash(es) formed using the salt 250. Thus, the remote entity 405 uses a rainbow table that is pre-computed to recreate the integrity checks from the attestation hash(es) according to the shared secret. From the rainbow table, the remote entity 405 is able to retrieve the time that is encoded as the salt 250 within the attestation hash(es). Accordingly, the remote entity 405 is able to assess the results without re-hashing the system data 240. The remote entity 405 may further traverse the attestation hashes from prior attestations in order to confirm the integrity of the vehicle 100 overall.

Based on the results, including the time retrieved from the attestation hash(es) according to the rainbow table, the remote entity 405 may proceed to traverse the attestation hashes of the list to identify when the attesting system was potentially compromised. From the acquired information, the remote entity 405 then generates a result that includes providing an attestation response to the vehicle 100. In general, there are three possible outcomes to the validation of the attestation. The first is that the attestation is successful, and, in this case, the remote entity 405 may simply provide an attestation response specifying the confirmation to which the vehicle 100 clears the hashes generated for the attestation and proceeds as normal. The second is that the attestation fails by the attestation hash(es) not matching or otherwise being unretrievable via the rainbow table indicating that the system data 240 is not valid and has been corrupted. The last option is that the attestation hash(es) are valid, but the remote entity 405 retrieves a time using the rainbow table from the attestation hash(es) that fails to satisfy the risk threshold. That is, when the remote entity 405 retrieves time from the attestation hash, the remote entity 405 then compares the time with a risk threshold. In one example, the remote entity 405 determines a difference between the retrieved time and an expected time at which the remote entity 405 believes the attestation should have occurred. When the difference, for example, exceeds the risk threshold (e.g., >10 seconds), then the remote entity 405 provides the attestation response requesting the vehicle 100 to perform a priority attestation. The vehicle 100 will then perform the attestation again, to which the remote entity 405 then assesses the timing again. If the vehicle 100 fails a defined number of times at providing the attestation within the risk threshold, then the remote entity 405 may determine that the attestation has failed due to, for example, a time-of-check time-of-use (TOCTOU) attack.

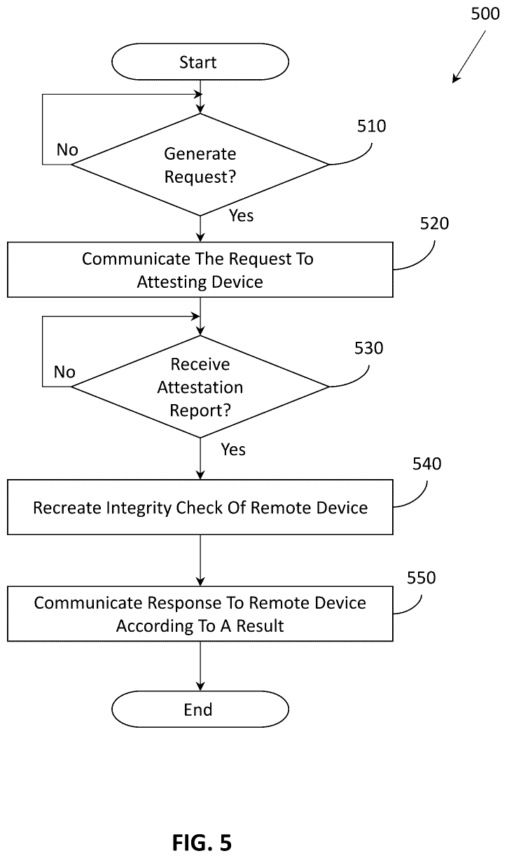

Additional aspects of remote attestation using a salt to embed time information will be discussed in relation to FIG. 5. FIG. 5 illustrates a method 500 associated with requesting attestation and validating the results of attestation. Method 500 will be discussed from the perspective of the security system 170 of FIG. 2. While method 500 is discussed in combination with the security system 170, it should be appreciated that the method 500 is not limited to being implemented within the security system 170 but is instead one example of a system that may implement the method 500. Moreover, it should be noted that as described in FIG. 5, the method 500 is executing in a remote entity that is generating the attestation request for validating the vehicle 100.

At 510, the remote entity generates and communicates, at 520, an attestation request. In one arrangement, the remote entity generates the attestation request as a regular monitoring function to check the vehicle 100 for continued integrity. In a further example, the remote entity generates the attestation request when connecting with the vehicle 100 to provide a service and/or to receive information from the vehicle 100. In general, the attestation request and subsequent verification function as a way for the remote entity to verify the integrity of the vehicle 100. The form of the attestation request itself may vary depending on the implementation but generally includes a generic request for the attestation hash(es) of the vehicle 100 and may further include verification information about the requesting party, such as a signed digital certificate or other cryptographic element to verify the identity of the source.

At 530, the remote entity monitors for a response from the attesting device. For example, the control module 220 of the remote entity monitors for a communication from the attesting device in response to the original attestation request. If received, then the control module 220 proceeds with method 500 by processing the response that includes an attestation report. Otherwise, the monitoring continues.

At 540, the control module 220 parses the response from the attesting device and proceeds to recreate the integrity check(s) of the remote device. As previously noted, the attestation hash(es) may take a different form depending on the implementation. In one instance, the attestation hash is a hash of at least one integrity hash, which is a direct hash of the system data 240. In a further arrangement, the integrity hashes are direct hashes of the system data 240 itself. In both instances, the attesting device may provide a list of attestation hashes from prior (i.e., intervening) integrity checks performed independently by the vehicle 100. In one or more approaches, the control module 220 recreates the one or more integrity checks using a rainbow table. As previously described, the rainbow table is a table that includes precomputed values specific to the remote device. For example, the control module 220 in the remote entity can precompute the rainbow table according to the different times at which the salt 250 may have been formed. Thus, the control module 220 is generally aware of when the attesting device receives the attestation request and, thus, when the attesting device is expected to perform the attestation. As such, the control module 220 is able to generate the rainbow table with values for the time within the salt that are within a range of the expected time for performing the attestation. The control module 220 may generate the rainbow table using, for example, one-second intervals across one minute around the expected time. Of course, the interval may generally depend on the precision of the time that is being used to generate the salt 250 so that the values align. In the instance of the prior intervening attestation hashes, the control module 220 may have awareness of a schedule by which the vehicle 100 generated the hashes or the attestation report may include some indication of when the prior attestations occurred (e.g., an encrypted schedule).

In any case, the control module 220 uses, in one approach, the valid value of the integrity check along with the shared secret and the various values of the time to precompute the rainbow table. The control module 220 is then able to use the rainbow table to recreate the integrity checks by performing a lookup using the shared secret. In one or more approaches, the control module 220 may use the shared secret and the valid value of the integrity hash as stored locally at the remote entity to perform the lookup. This can include analyzing the current attestation hash(es) traversing attestation hashes provided in the report from prior times.

At 550, the control module 220 communicates a response to the remote device according to a result associated with the integrity checks. In one approach, the control module 220 determines whether the integrity checks are valid and whether the time associated with the attestation hash satisfies a risk threshold. That is, for example, the control module 220 determines whether a time at which the remote device performed attestation is within an expected difference from an expected time for the remote device to perform attestation. Thus, the risk threshold defines a time range that is acceptable (e.g., 10 s), and if the decoded time from the attestation hash exceeds the expected time by more than the risk threshold, the result is not trusted. In this case, the response provided by the remote entity to the attesting device may specify a request for a priority attestation (i.e., an immediate attestation performance by the attesting device) or failure of the attestation if, for example, the attestation was previously failed.

If the attestation was successful, then, in one arrangement, the control module 220 generates a report to indicate the successful attestation and may include a copy of the attestation hash provided by the vehicle 100, which can then be logged. However, if the attestation fails, then the remote entity generates the report, at least in part, as a communication to the vehicle 100. In at least one approach, the control module 220 determines that the attestation is a failure according to, for example, a defined number of attestations that fail the risk threshold, which generally indicates a failure of the attesting device to perform the attestation within the excepted timeframe. This can be indicative of various malicious attacks on the attesting device. In a further aspect, the control module 220 determines the failure according to the rainbow table. That is, the lookup of the integrity check may fail if the provided attestation hash includes values that are not valid. Accordingly, the control module 220 is also able to verify the underlying data using the rainbow table.

The remote entity can mitigate the integrity failure from the attack according to a mitigation deployment in the form of one or more mitigation actions identified in the report. The control module 220 may also log the source of the integrity failure in a retained copy of the report.

The remote entity may provide the report by logging the report in a local attestation log and/or by communicating the report to the vehicle 100. The remote entity may communicate the report as a mitigation deployment to the vehicle 100 in order to correct the failure or at least prevent further damage. For example, the mitigation deployment is a control communicated to the vehicle 100 that causes the vehicle 100 to perform one or more mitigation actions. The actions can include restoring the software component(s) to a prior state using a system image, instantiating a fail-safe mode within the vehicle 100, or performing another action to remediate the failure. While the mitigation deployment is described as being a control, the deployment may further include one or more files (e.g., images) for the vehicle 100 to use when performing the mitigation.

The control module 220 within the vehicle 100 mitigates the integrity failure from an attack according to the mitigation deployment. That is, the vehicle 100 executes one or more actions using existing functionality or through an executable provided by the remote device in order to correct the integrity failure. In this way, the security system 170 is able to use the hash to secure the vehicle 100 and trace failures when they occur, thereby improving the operation of the associated computing systems and robustness against attack.

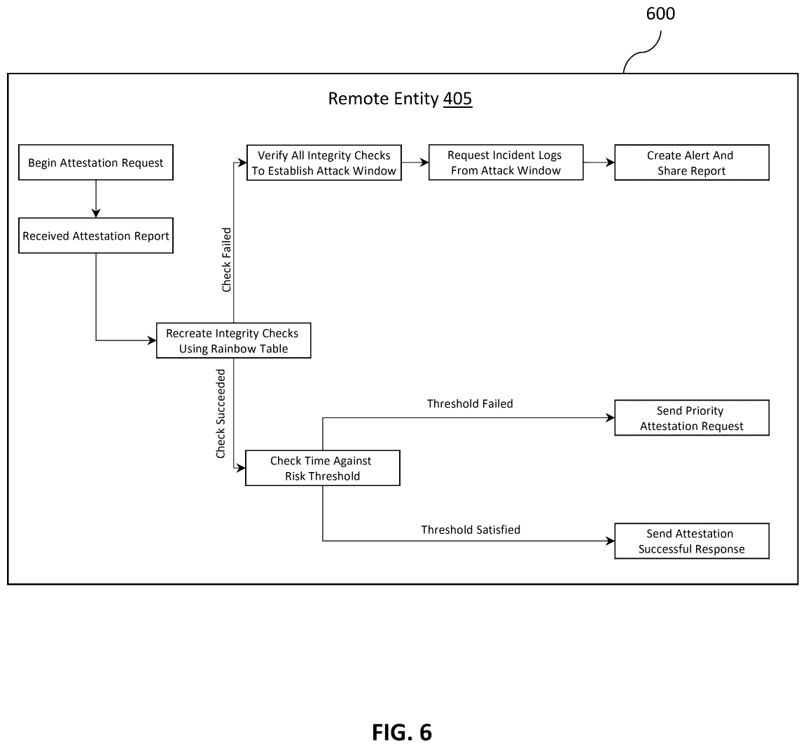

FIG. 6 illustrates an example 600 of the remote entity 405 and functions performed within the remote entity 405 for validating the report provided by the vehicle 100. As shown, the remote entity 405 performs a version of the method 500, which is shown in an abbreviated form. In any case, the remote entity 405 performs a different set of functions depending on the result of the attestation within the vehicle 100. In particular, the remote entity 405 uses the rainbow table to verify the attestation result according to the attestation hash provided by the attesting device. If the result is invalid and the check has failed, then the remote entity 405 proceeds to verify all integrity checks in order to establish an attack window. That is, for example, the remote entity 405 can verify integrity checks from intervening points in time between attestations in order to assess when the system data 240 became corrupted. As such, the remote entity 405 can then request incident logs from the attack window to better focus the forensic analysis and may further generate one or more alerts while providing a report about the incident.

Separately, when the remote entity 405 determines the attestation hash indicates a valid attestation using the rainbow table, the remote entity 405 may proceed with checking the timing of the attestation to ensure it was performed when expected and the system data 240 has not been compromised and falsely replaced to provide the successful result. Accordingly, the remote entity 405 uses the time determined from the rainbow table to assess whether the attestation was performed in a timely manner. If the time does not satisfy (e.g., exceeds) the risk threshold, then the remote entity 405 sends a priority attestation request to the attesting device to verify the result. Otherwise, the remote entity determines that the attestation is successful and satisfies the threshold and generates a successful attestation response. In this way, the present approach is able to verify the timing of the attestation and determine if a time-of-check time-of-use (TOCTOU) is occurring, thereby improving the security against additional attacks.

Additionally, it should be appreciated that the security system 170 from FIG. 1 can be configured in various arrangements with separate integrated circuits and/or electronic chips. In such embodiments, the control module 220 is embodied as a separate integrated circuit. The circuits are connected via connection paths to provide for communicating signals between the separate circuits. Of course, while separate integrated circuits are discussed, in various embodiments, the circuits may be integrated into a common integrated circuit and/or integrated circuit board. Additionally, the integrated circuits may be combined into fewer integrated circuits or divided into more integrated circuits. In further embodiments, portions of the functionality associated with the module 220 may be embodied as firmware executable by a processor and stored in a non-transitory memory. In still further embodiments, the module 220 is integrated as hardware components of the processor 110.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver).

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the security system 170 to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 (e.g., data store 230) for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected” or “communicably connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps.

The one or more data stores 115 can include sensor data. In this context, “sensor data” means any information from the sensors that the vehicle 100 is equipped with, including the capabilities and other information about such sensors.

As noted above, the vehicle 100 can include the sensor system 120. The sensor system 120 can include one or more sensors. “Sensor” means any device, component, and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The vehicle sensor(s) 121 can be configured to detect and/or sense one or more characteristics of the vehicle 100. In one or more arrangements, the vehicle sensor(s) 121 can include a speedometer to determine a current speed of the vehicle 100. Moreover, the vehicle sensor system 121 can include sensors throughout a passenger compartment, such as pressure/weight sensors in seats, seatbelt sensors, camera(s), and so on.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1, however, the vehicle 100 can include a different combination of systems than illustrated in the provided example. In one example, the vehicle 100 can include a propulsion system, a braking system, a steering system, throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a global positioning system, a local positioning system or a geolocation system.

The processor(s) 110, the security system 170, and/or the assistance system 160 can be operatively connected to communicate with the various vehicle systems 150 and/or individual components thereof. For example, returning to FIG. 1, the processor(s) 110 and/or the assistance system 160 can be in communication to send and/or receive information from the various vehicle systems 150 to control the movement, speed, maneuvering, heading, direction, etc. of the vehicle 100. The processor(s) 110, the security system 170, and/or the assistance system 160 may control some or all of these vehicle systems 150 and, thus, may be partially or fully autonomous.

The processor(s) 110, the security system 170, and/or the assistance system 160 can be operatively connected to communicate with the various vehicle systems 150 and/or individual components thereof. For example, returning to FIG. 1, the processor(s) 110, the security system 170, and/or the assistance system 160 can be in communication to send and/or receive information from the various vehicle systems 150 to control the movement, speed, maneuvering, heading, direction, etc. of the vehicle 100. The processor(s) 110, the security system 170, and/or the assistance system 160 may control some or all of these vehicle systems 150.

The processor(s) 110, the security system 170, and/or the assistance system 160 may be operable to control the navigation and/or maneuvering of the vehicle 100 by controlling one or more of the vehicle systems 150 and/or components thereof. For instance, when operating in an autonomous mode, the processor(s) 110, the security system 170, and/or the assistance system 160 can control the direction and/or speed of the vehicle 100. The processor(s) 110, the security system 170, and/or the assistance system 160 can cause the vehicle 100 to accelerate (e.g., by increasing the supply of energy provided to the engine), decelerate (e.g., by decreasing the supply of energy to the engine and/or by applying brakes) and/or change direction (e.g., by turning the front two wheels).

Moreover, the security system 170 and/or the assistance system 160 can function to perform various driving-related tasks. The vehicle 100 can include one or more actuators. The actuators can be any element or combination of elements operable to modify, adjust and/or alter one or more of the vehicle systems or components thereof responsive to receiving signals or other inputs from the processor(s) 110 and/or the assistance system 160. Any suitable actuator can be used. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, generative AI, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more modules that form the assistance system 160. The assistance system 160 can be configured to receive data from the sensor system 120 and/or any other type of system capable of capturing information relating to the vehicle 100 and/or the external environment of the vehicle 100. In one or more arrangements, the assistance system 160 can use such data to generate one or more driving scene models. The assistance system 160 can determine the position and velocity of the vehicle 100. The assistance system 160 can determine the location of obstacles, or other environmental features, including traffic signs, trees, shrubs, neighboring vehicles, pedestrians, and so on.

The assistance system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The assistance system 160, either independently or in combination with the security system 170, can be configured to determine travel path(s), current autonomous driving maneuvers for the vehicle 100, future autonomous driving maneuvers, and/or modifications to current autonomous driving maneuvers based on data acquired by the sensor system 120, driving scene models, and/or data from any other suitable source such. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The assistance system 160 can be configured to implement determined driving maneuvers. The assistance system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The assistance system 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product, which comprises all the features enabling the implementation of the methods described herein and, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that, when executed, perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, generative, AI, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A security system, comprising:
one or more processors;
a memory communicably coupled to the one or more processors and storing:
a control module including instructions that, when executed by the one or more processors, cause the one or more processors to:
responsive to communicating a remote attestation request to a remote device, receive an attestation report from the remote device that includes an attestation report, the attestation report including at least one attestation hash that is formed from a salt and one or more integrity checks of data from the remote device that is to be verified;
recreate the one or more integrity checks using a rainbow table; and
communicate a response to the remote device according to a result associated with the attestation report.

2. The security system of claim 1, wherein the control module includes instructions to recreate the integrity checks including instructions to precompute the rainbow table according to different times at which the salt may have been formed, the salt including a shared secret and a time.

3. The security system of claim 2, wherein the control module includes instructions to recreate the integrity checks including instructions to precompute the rainbow table using a valid value of the data from the remote device with the salt formed from the shared secret and multiple different times at which the attestation hash could have been formed, and
wherein the control module includes instructions to recreate the integrity checks including instructions to perform a lookup using the rainbow table according to the shared secret and the valid value.

4. The security system of claim 1, wherein the control module includes instructions to communicate the response including instructions to determine whether the at least one attestation hash is valid and whether a time associated with the attestation hash satisfies a risk threshold.

5. The security system of claim 4, wherein the control module includes instructions to determine whether the time associated with the at least one attestation hash satisfies the risk threshold including instructions to determine whether a time at which the remote device performed attestation is within an expected difference from an expected time for the remote device to perform attestation.

6. The security system of claim 1, wherein the control module includes instructions to communicate the response including instructions to request the remote device to one or more of: perform a priority attestation, provide incident logs, and generate a report according to the result.

7. The security system of claim 1, wherein the control module includes instructions to recreate the one or more integrity checks including instructions to traverse a list of attestation hashes, including the at least one attestation hash, in the attestation report using a rainbow table to identify when the data was corrupted, and wherein the integrity checks are the data of the remote device.

8. The security system of claim 1, wherein the remote device is a vehicle.

9. A non-transitory computer-readable medium storing instructions that, when executed by one or more processors, cause the one or more processors to:
responsive to communicating a remote attestation request to a remote device, receive an attestation report from the remote device that includes an attestation report, the attestation report including at least one attestation hash that is formed from a salt and one or more integrity checks of data from the remote device that is to be verified;
recreate the one or more integrity checks using a rainbow table; and
communicate a response to the remote device according to a result associated with the attestation report.

10. The non-transitory computer-readable medium of claim 9, wherein the instructions to recreate the integrity checks including instructions to precompute the rainbow table according to different times at which the salt may have been formed, the salt including a shared secret and a time.

11. The non-transitory computer-readable medium of claim 10, wherein the instructions to recreate the integrity checks including instructions to precompute the rainbow table using a valid value of the data from the remote device with the salt formed from the shared secret and multiple different times at which the attestation hash could have been formed, and
wherein the instructions to recreate the integrity checks including instructions to perform a lookup using the rainbow table according to the shared secret and the valid value.

12. The non-transitory computer-readable medium of claim 9, wherein the instructions to communicate the response include instructions to determine whether the at least one attestation hash is valid and whether a time associated with the attestation hash satisfies a risk threshold.

13. The non-transitory computer-readable medium of claim 12, wherein the instructions to determine whether the time associated with the attestation hash satisfies the risk threshold including instructions to determine whether a time at which the remote device performed attestation is within an expected difference from an expected time for the remote device to perform attestation.

14. A method, comprising:
responsive to communicating a remote attestation request to a remote device, receiving an attestation report from the remote device that includes an attestation report, the attestation report including at least one attestation hash that is formed from a salt and one or more integrity checks of data from the remote device that is to be verified;
recreating the one or more integrity checks using a rainbow table; and
communicating a response to the remote device according to a result associated with the attestation report.

15. The method of claim 14, wherein recreating the integrity checks includes precomputing the rainbow table according to different times at which the salt may have been formed, the salt including a shared secret and a time.

16. The method of claim 15, wherein recreating the integrity checks includes precomputing the rainbow table using a valid value of the data from the remote device with the salt formed from the shared secret and multiple different times at which the attestation hash could have been formed, and
wherein recreating the integrity checks includes performing a lookup using the rainbow table according to the shared secret and the valid value.

17. The method of claim 14, wherein communicating the response includes determining whether the at least one attestation hash is valid and whether a time associated with the attestation hash satisfies a risk threshold.

18. The method of claim 17, wherein determining whether the time associated with the at least one attestation hash satisfies the risk threshold includes determining whether a time at which the remote device performed attestation is within an expected difference from an expected time for the remote device to perform attestation.

19. The method of claim 14, wherein communicating the response includes requesting the remote device to perform one or more of: perform a priority attestation, provide incident logs, and generate a report according to the result.

20. The method of claim 14, wherein recreating the one or more integrity checks includes traversing a list of attestation hashes, including the at least one attestation hash, in the attestation report using a rainbow table to identify when the data was corrupted, and wherein the integrity checks are the data of the remote device.
